(19) United States
(12) Patent Application Publication
(10) Pub. No.: US 2012/0006867 A1
(43) Pub. Date: Jan. 12, 2012

(54) Carrier for a Collapsible Chair

(76) Inventor: Tami Caldwell, Aurora, OH (US)

(21) Appl. No.: 13/176,023

(22) Filed: Jul. 5, 2011

Related U.S. Application Data
(60) Provisional application No. 61/361,608, filed on Jul. 6, 2010.

(51) Int. Cl. A45F 5/00; B23P 11/00

(52) U.S. Cl. 224/191; 29/428

(57) ABSTRACT

A device for fastening and carrying a collapsible chair comprising two straps and a detachable carrying piece that releasably connects to a connecting member of each strap. Each strap comprises a releasable fastening means for adjustably fastening each strap around the collapsed chair. Each strap has an adhesive backing to attach the strap to a support column of the chair.

### CROSS-REFERENCES TO RELATED APPLICATIONS

This patent application claims the benefit of provisional patent application Ser. No. 61/361,608, filed Jul. 6, 2010, hereby incorporated by reference.

### FIELD OF THE INVENTION

The invention relates generally to a flexible carrier for a collapsible chair and specifically to an aftermarket product having a detachable carrying piece that can be attached to carry a collapsible chair.

### BACKGROUND OF THE INVENTION

Numerous devices have been used for carrying collapsible portable seats or chairs. Outdoor collapsible chairs that are typically sold in a bag have a light weight tubular aluminum frame and canvas seat and back rest. These lightweight chairs are typically carried to sporting events or other outdoor events for temporary seating. A problem exists with collapsible chairs in that, once removed from the bag, they are difficult to get back into the bag. If the chair is not replaced into the bag, the chair does not remain collapsed, and may expand in a car trunk, making the chair harder to use.

U.S. Pat. No. 7,717,503 to Watson discloses a collapsible chair having a securing straps and a plastic shoulder strap permanently attached to one of the back legs. The carrier/chair in Watson, among other shortcomings, is expensive to manufacture, unnecessarily complicated, unsafe and difficult to clean. By being a permanent part of the manufactured chair, the carrier part of Watson presents numerous problems. First, Watson's device offers few choices to a consumer. A purchaser of Watson's chair must accept the style and color of the attached carrier. Second, the permanently attached plastic shoulder strap is a safety hazard. A child could become tangled in the strap and accidentally hang. Third, the shoulder strap and the securing straps will become worn out, tear or break and become unusable due to normal wear and exposure to sunlight and cold temperatures. Attachments made of plastic will break down (degrade with micro-cracks) and disintegrate from ultraviolet light penetration. Watson's carrier is attached at a single point to the leg, so when that point breaks, the carrier is unusable. Moreover, the shoulder strap is not adjustable so it cannot be adjusted to conform to the dimensions of the user (such as a woman vs a man) to allow for easy and stable carrying of the chair. In addition, the permanent strap does not have added padding, making carrying uncomfortable. The permanent strap will also become dirty with use. Cleaning may be of some help, but there is no way to easily replace the shoulder strap or the securing straps.

Accordingly, there is a need for a detachable aftermarket carrier for a collapsible chair that is inexpensive to manufacture, uncomplicated, safe and replaceable. It is an objective of the invention to provide a detachable carrier for easily carrying a collapsible chair that gives consumers a choice of colors and fabrics and provides connection means that are long lasting and durable. It is an object of the present invention to provide a new and improved carrier for a collapsible chair that has an adjustable shoulder strap with padding for user comfort and that can be replaced when damaged or soiled.

### SUMMARY OF THE INVENTION

The present invention is an aftermarket device that fits most collapsible chairs typically used for outdoor events. The device comprises a first strap and a second strap, each strap comprising a connecting end and a free end. The free end comprises a detachable fastening means for adjustably fastening the strap around the collapsed chair. An adhesive backing extends over at least a portion of the connecting end of each strap. The adhesive backing is of sufficient length such that when a portion of the adhesive backing is attached to a support column of the chair, the adhesive backing encircles and is in contact with the support column. Each strap is in longitudinal alignment when connected around the chair. In an embodiment, each strap is elastic. In an embodiment, the adhesive backing comprises a removable protective film covering the adhesive backing.

A plurality of female loops extends from at least a portion of one side of each strap and a plurality of male hooks extend from at least a portion of the other side of each strap. Each strap is of sufficient length to be wrapped around the collapsed chair perpendicular to the support columns and to place a portion of the plurality of female loops in mating contact with a portion of the plurality of male hooks extending from that strap.

The device further has a carrying piece. Each end of the carrying piece has a coupling device to connect to a coupling member located at each strap's connecting end. In an embodiment, the coupling member is a metal D-ring and the carrying piece coupling device is a metal clasp.

To use the device to secure and carry a collapsible chair, two straps are wrapped around a supporting column of the chair at a first and second location. One end of each strap comprises of a plurality of male hooks extending from at least a portion of one side and (i) a plurality of female loops extending from at least a portion of, and (ii) an adhesive backing covering at least a portion of, the other side, so that a first portion of the adhesive backing of each strap is in adhering contact with each location on the supporting column of the chair. Each strap is wrapped around the collapsed chair at each location such that the female loops are placed in mating contact with the male hooks and each strap is in longitudinal alignment when connected. A carrying piece is detachably attached to a connecting end of each strap at a coupling member.

The device and method of the present invention can comprise, consist of, or consist essentially of the essential elements and limitations of the invention described herein, as well as any additional or optional components or limitations described herein or otherwise useful in systems and methods of the general type as described herein. All combinations of method or process steps as used herein can be performed in any order, unless otherwise specified or clearly implied to the contrary by the context in which the referenced combination is made.

All references to singular characteristics or limitations of the present invention shall include the corresponding plural characteristic or limitation, and vice versa, unless otherwise specified or clearly implied to the contrary by the context in which the reference is made.

### DRAWING FIGURES

FIG. 1 is a perspective view of a strap of the invention.

FIG. 2 is a perspective view of a strap being attached to a leg or support of the chair.

FIG. 3 is a perspective view of a carrying piece.

FIG. 4 is a perspective view of the straps mounted on a chair.

FIG. 5 is a perspective view of the carrier after the straps have been secured around the collapsed chair and the carrying piece has been attached.

FIG. 6 is a perspective view of the carrier on the shoulder of a user.

### DETAILED DESCRIPTION OF THE INVENTION

The present invention provides a collapsible chair carrier comprising: (a) two spaced apart independent straps for attaching at points on a leg or support of a chair a given distance from the top and bottom of the chair and encircling the collapsed chair around the collapsed legs or supports, and (b) a detachable carrying piece with metal attaching means and padding. Various materials may be used for the straps and the carrying piece including most textile materials, polymeric materials, nylon webbing or any other suitable material that is strong, flexible, and elongated. The straps may be non-elastic or elastic and the carrying piece is formed from a non-elastic material. The straps and the carrying piece are manufactured in a wide variety of colors, patterns and designs. A user can select a carrier that easily identifies the chair as his/hers when many collapsible chairs are present (such as at a child's soccer game).

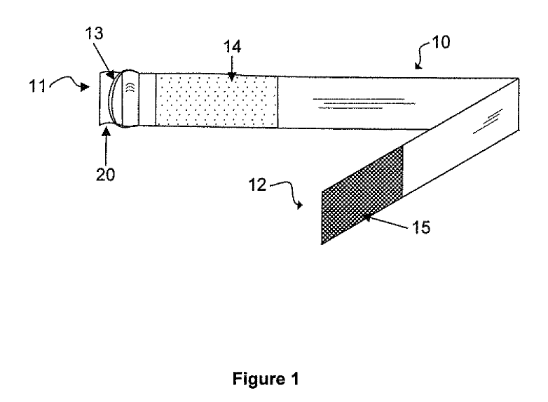

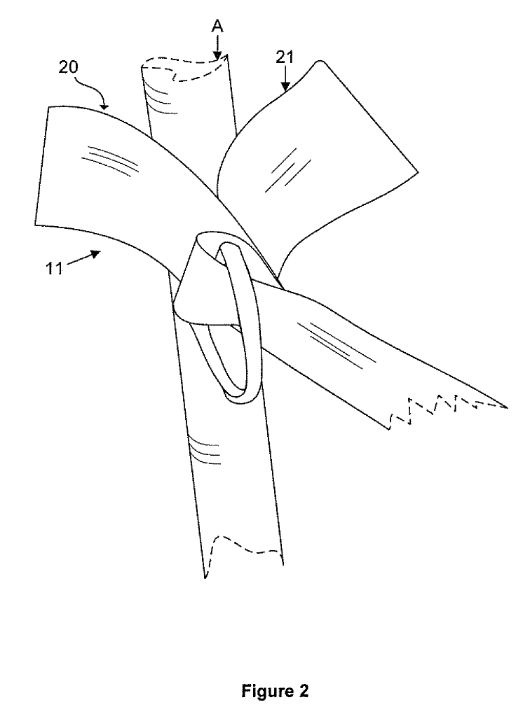

As shown in FIG. 1, each strap 10 is a flexible longitudinal length having an inner and an outer face. During use, the inner face faces the collapsed chair to which the device is attached, while the outer face faces away from the chair, Each strap 10 is comprised of a connecting end portion 11, a free end portion 12, a coupling member 13 and an industrial strength adhesive backing 20 with a protective film 21 (shown in FIG. 2), which extends from the connecting end portion 11. The coupling member 13 is secured to the strap. The coupling member 13 is any durable releasable connecting means formed from a durable material, such as a hard plastic, metal, such as a D-ring, snaps, clips, clasps, grommets, buttons, buckles, hooks, and the like.

In an embodiment, the coupling member 13 is an about 2″ half D-ring and the connecting end portion 11 of the strap is folded over the straight part of the ring and securely fastened, such as by hot gluing, stitching, grommeting, taping, and the like. As depicted if FIG. 1, the D-ring is placed near the end of the strap. In an alternate embodiment, the D-ring is attached with a piece of additional strap and or other connection and stitching and or VELCRO™ tape near the middle of the strap.

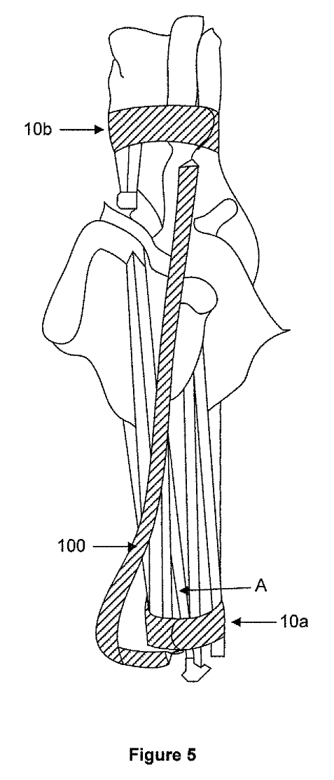

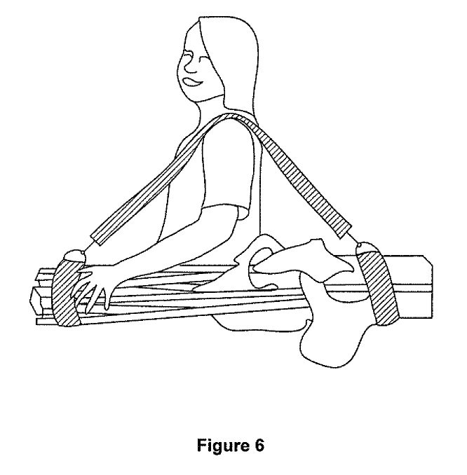

The device has means for connecting the free end portion 12 of the strap 10 to a portion of itself for adjustably fastening each strap around a collapsed chair (depicted in FIG. 5 and FIG. 6). A section of Velcro-type female loops 14 extends from strap 10 at a point near the coupling member 13 on the outer face. In an alternate embodiment, the female loops 14 extends from strap 10 on the outer face at the connecting end portion 11. A section of Velcro-type male hooks 15 extends from strap 10 at a point near the connecting end 12 on the inner face of the strap. “Velcro-type” means of the type employed in separable fasteners that are marketed by Velcro USA, Inc., 406 Brown Avenue, Manchester, N.H., under the trademarks VELCRO® hook and loop fasteners, and VELCRO STICKY BACK™ strips of hook and loop fasteners with adhesive backing type of VELCRO® brand tape which has a peel-off backing. The tape is also sold under the STICKY BACK® Brand name.

A variety of dimensions for the straps and the carrying piece may be used and are within the scope of the invention. Preferably, the strap is of sufficient length to be wrapped the circumference to encircle the collapsed chair such that at least a portion of the male hooks are in mating contact with at least a portion of the female loops. The carrying piece should be of sufficient length for a user to carry the collapsed chair at or below the elbow when the carrying piece is on the shoulder (which can be adjusted to that length). In an embodiment, the straps are about 20″ long and about 2″ wide. In an embodiment, a first strap is about 21″ long. In an embodiment, a second strap is about 22″ long. Other dimensions may be used and are within the scope of this invention,

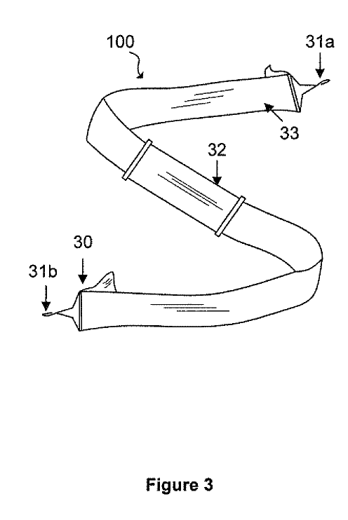

As shown in FIG. 3, the present invention provides an adjustable carrying piece 100 releasably attachable to each strap when the chair is collapsed for hand or over the shoulder use. The detachable feature of the carrying piece of the present invention allows the carrying piece to be removed—thereby eliminating worry over someone tripping over it or getting caught in it, or a child becoming entangled in the carrying piece when no one is watching if the carrying piece remains attached to the chair when the chair is deployed. The detachable carrying piece also allows a user to replace the carrying piece if it becomes soiled, worn out, tears or breaks, or even to change to a different color or pattern if the user so desires.

The coupling member 13 of each strap is connected to a connecting end 31a, 31b at each end of the carrying piece 100. In an embodiment, connecting ends 31a, 31b are snap hooks comprising a swivel attachment. One skilled in the art would understand that any metal releasably attachable means, such as a D-ring, snaps, clips, grommets, buttons, buckles, hooks and the like, may be substituted for the clasp-D-ring arrangement.

The carrying piece includes means 30 to adjust the piece to a suitable length. In an embodiment, the adjusting means 30 is a metal bracket that the body 33 of the carrying piece slides through in either direction to lengthen or shorten the carrying piece. The carrying piece 100 includes one or more additional element 32 that provides comfort or maintains the carrying piece 100 on a user's shoulder. In an embodiment, the additional element is an adjustable elastomeric shoulder pad attached to the carrying piece. In an embodiment, the carrying piece is a pre-made shoulder strap available in department stores.

In an embodiment, the Velcro-type male hooks 15 and the Velcro-type female loops 14 comprise a portion of the relative face surfaces of the strap. The dimensions of the Velcro-type male hooks 15 and Velcro-type female loops 14 and their placement along the length of relative face of the strap may vary and can comprise the entire surface, but preferentially, the Velcro-type male hooks 15 and Velcro-type female loops 14 extend the entire width of the strap. In an embodiment, the Velcro-type male hooks 15 and Velcro-type female loops 14 comprise an about 4″ portion along each relative face of the strap.

As shown in FIG. 2, when the adhesive backing 20 is placed in contact with a chair support or leg A after removal of the protective film 21, the adhesive backing 20 secures the strap to the chair support or leg A around the circumference of the leg. Prior to placing it in contact with chair support or leg A, the removable protective film 21 is removed to facilitate handling of the device and to prolong the useful life of adhesive backing 20. The adhesive backing 20 is securely attached to the connecting end portion 11 at the inner face by stitching, chemical or heat bonding, gluing, grommeting or some other suitable technique. In an embodiment, the adhesive backing 20 and protective film 21 is a piece of VELCRO STICKY BACK™ hook and loop fasteners with adhesive backing. The adhesive backing wraps around the chair leg to provides a wide area high strength bond between the strap and the chair leg to provide a more secure and durable attachment. The adhesive backing adheres to metal and withstands sunlight and wide fluctuations in temperature for outdoor applications.

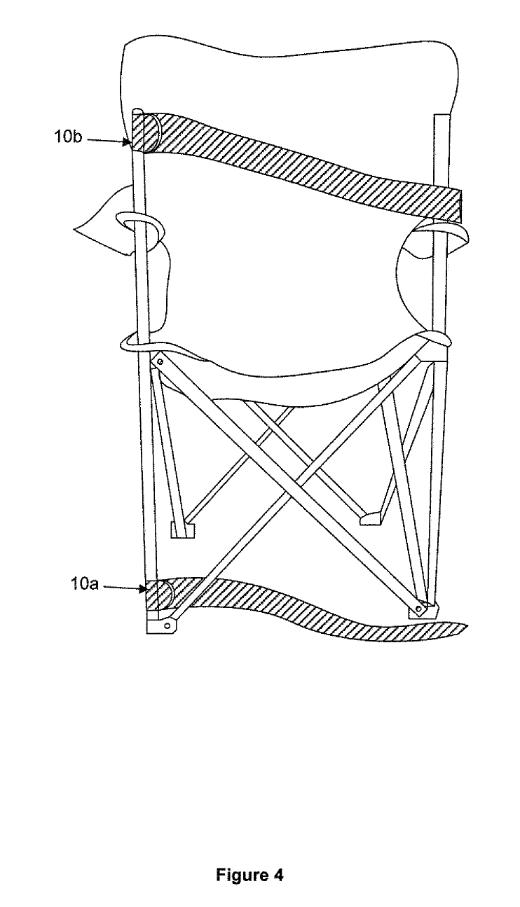

Referring to FIG. 4, to use the device, the protective film 21 is removed from the adhesive backing 20 of a first strap 10a, and the adhesive backing is wrapped around and adhesively attached to the back left leg near the ground side to attach the strap 10a. The protective film 21 is removed from the adhesive backing 20 of a second strap 10b and the adhesive backing is wrapped around and adhesively attached to the upper part of the left back leg near the top that supports the back of the chair. The chair is collapsed and each free end portion 12 of each strap is wrapped circumferentially around the collapsed chair. Each strap is secured to itself in an overlapping fashion by putting the free end portion 12 through the D-ring 13, tightening the strap, and fastening the hooks to the loops. A first connecting end 31a of the carrying piece 100 is attached to the coupling member 13 of the first strap 10a, and a second connecting end 31b of the carrying piece 100 is attached the coupling member 13 of the second strap 10b. The collapsed chair may be carried or stored using the device. FIG. 5 depicts the present invention in use on a collapsed chair. FIG. 6 shows the ease of carry the chair on a users shoulder.

To deploy the chair, the hook and loop of each strap is separated by peeling apart and the strap is unwound from the circumference of the collapsed chair. The chair may then be fully extended for use and the carrying piece removed. The straps remain attached to the chair leg for future use, but can be removed if the user so desires. In an embodiment, each support column of the chair opposite the column having the strap attached has an attachment means to secure each strap. In an embodiment, the attachment means is attached to the support column at approximately the same height as that of the attached strap. In an embodiment, the free strap attachment means is a piece of VELCRO STICKY BACK™.

The foregoing descriptions of specific embodiments of the present invention have been presented for purposes of illustration and description. They are not intended to be exhaustive or to limit the invention to the precise forms disclosed, and obviously many modifications and variations are possible in light of the above teachings. It will be understood that the invention is intended to cover alternatives, modifications and equivalents. The embodiments were chosen and described in order to best explain the principles of the invention and its practical application, to thereby enable others skilled in the art to best utilize the invention and various embodiments with various modifications as are suited to the particular use contemplated. It is therefore to be understood that within the scope of the appended claims, the invention may be practiced otherwise than as specifically described herein.

I claim:

1. A device for detachably fastening and carrying a collapsible chair, the device comprising:
(a) a first strap and a second strap, each strap comprising:
(i) a connecting end and a free end; the free end comprising detachable fastening means for adjustably fastening the strap around the collapsed chair;
(ii) an adhesive backing extending from the connecting end, the adhesive backing of sufficient length such that when a portion of the adhesive backing is attached to a support column of the chair, the adhesive backing encircles the column;
(iii) a metal coupling member attached to each strap; and
(iv) a plurality of female loops extending from at least a portion of one side of each strap and a plurality of male hooks extending from at least a portion of the other side of each strap, each strap being of sufficient length (1) to be wrapped around the collapsed chair perpendicular to the support columns, and (2) to place a portion of the plurality of female loops in mating contact with a portion of the plurality of male hooks extending from that strap; and
(b) an adjustable length carrying piece, each end of the carrying piece having a metal coupling device to releasably connect to each strap's coupling member.

2. A device according to claim 1 wherein each strap is in longitudinal alignment when connected.

3. A device according to claim 1 further comprising a removable protective film covering the adhesive backing.

4. A device according to claim 1 wherein the carrying end coupling member is a D-ring and the carrying piece coupling device is a clasp.

5. A device according to claim 1 wherein each strap is elastic.

6. A method of detachably fastening and carrying a collapsible chair, the method comprising:
(a) wrapping around a supporting column of the chair at a first and second location, one end of a strap, each strap being comprised of a plurality of male hooks extending from at least a portion of one side and (i) a plurality of female loops extending from at least a portion of, and (ii) an adhesive backing covering at least a portion of, the other side, so that a first portion of the adhesive backing of each strap is in adhering contact with each location on the supporting column of the chair;
(b) wrapping around the collapsed chair at each location, the other end of each strap, such that the female loops are placed in mating contact with the male hooks and each strap is in longitudinal alignment when connected;
(c) attaching an adjustable length releasably attachable carrying piece to a metal coupling member located on each strap and adjusting the length of the carrying piece.
